(19) United States
(12) Patent Application Publication
(10) Pub. No.: US 2026/0066803 A1
(43) Pub. Date: Mar. 5, 2026

(54) CONTROL INTEGRATED CIRCUIT AND SWITCHING POWER SUPPLY CIRCUIT

(71) Applicant: ROHM CO., LTD., Kyoto (JP)

(72) Inventor: Takumi FUJIMAKI, Kyoto (JP)

(21) Appl. No.: 19/306,094

(22) Filed: Aug. 21, 2025

(30) Foreign Application Priority Data
Aug. 28, 2024 (JP) 2024-146257

(51) Int. Cl. H02M 3/335; H02M 1/00; H02M 1/42

(52) U.S. Cl. CPC H02M 3/33569; H02M 1/0009; H02M 1/4208

(57) ABSTRACT

A switching power supply circuit includes: a rectifier circuit; a DC/DC converter; a power factor correction IC configured to have a power factor correction function; and a control IC. The control IC includes: a first terminal configured to receive a feedback voltage based on a DC output voltage output from the DC/DC converter; and a second terminal. The control IC is configured to control a switching element according to the feedback voltage. The control IC is further configured to output a voltage for ON/OFF-controlling the power factor correction function from the second terminal.

### CROSS REFERENCE TO RELATED APPLICATION

The present invention claims priority under 35 U.S.C. § 119 to Japanese Patent Application No. 2024-146257, filed on Aug. 28, 2024, the entire contents of which are incorporated herein by reference.

### TECHNICAL FIELD

The present disclosure relates to a control integrated circuit (IC) and a switching power supply circuit.

### BACKGROUND

A power factor correction circuit monitors an alternate current input voltage and an alternate current input current of a power supply device that performs alternate current/direct current (AC/DC) conversion, and roughly matches their phases to bring a power factor close to 1 (i.e., 100%).

In applications that require low standby power such as AC adapters, a two-stage configuration including a power factor correction IC and a control IC configured to control a switching element included in a DC/DC converter is mainstream in a power band of about 100 W.

### BRIEF DESCRIPTION OF DRAWINGS

The accompanying drawings, which are incorporated in and constitute a part of the specification, illustrate embodiments of the present disclosure.

FIG. 1 is a diagram showing a configuration of a switching power supply circuit according to a first embodiment.

FIG. 2 is an external perspective view of a power factor correction IC and a control IC.

FIG. 3 is a diagram showing a schematic configuration of the power factor correction IC.

FIG. 4 is a diagram showing a configuration of a control circuit provided in the control IC according to the first embodiment.

FIG. 5 is a diagram showing a configuration of a voltage generation circuit provided in the control IC according to the first embodiment.

FIG. 6 is a diagram showing a relationship between an effective value of an AC input voltage and output power when a power factor correction function of the power factor correction IC switches from OFF to ON in the first embodiment.

FIG. 7 is a diagram showing a configuration of a switching power supply circuit according to a second embodiment.

FIG. 8 is a diagram showing a first configuration example of a voltage generation circuit provided in a control IC according to the second embodiment.

FIG. 9 is a diagram showing a relationship between an effective value of an AC input voltage and output power when a power factor correction function of a power factor correction IC switches from OFF to ON in the second embodiment.

FIG. 10 is a diagram showing a second configuration example of the voltage generation circuit provided in the control IC according to the second embodiment.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### First Embodiment

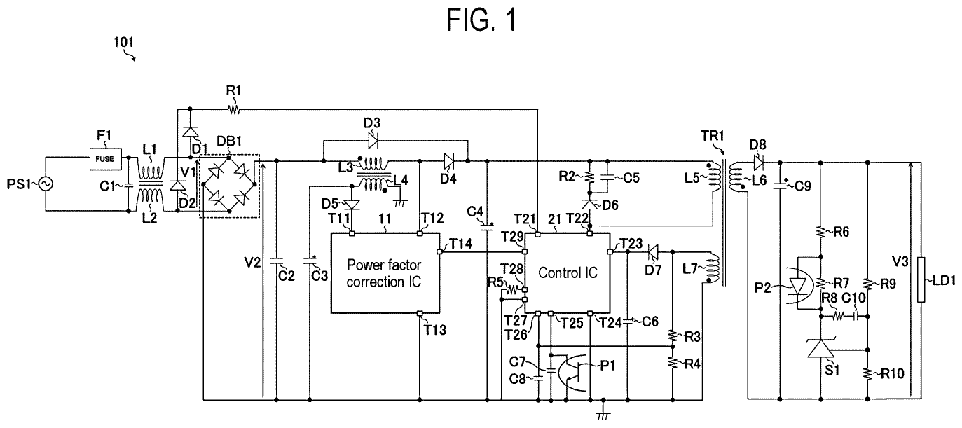

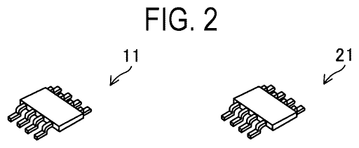

FIG. 1 is a diagram showing a configuration of a switching power supply circuit 101 according to a first embodiment. FIG. 2 is an external perspective view of a power factor correction IC 11 and a control IC 21. The power factor correction IC 11 and the control IC 21 are electronic components formed by enclosing a semiconductor chip in a housing (package) made of resin. A plurality of external terminals is exposed from the housing of the power factor correction IC 11, and includes terminals T11 to T14 shown in FIG. 1. The power factor correction IC 11 may have external terminals other than the terminals T11 to T14 shown in FIG. 1. A plurality of external terminals is exposed from the housing of the control IC 21, and includes terminals T21 to T29 shown in FIG. 1. The control IC 21 may have external terminals other than the terminals T21 to T29 shown in FIG. 1. In addition, the number of external terminals of each of the power factor correction IC 11 and the control IC 21 and appearance of each of the power factor correction IC 11 and the control IC 21 shown in FIG. 2 are merely examples.

The switching power supply circuit 101 according to the first embodiment is connected to an AC power supply PS1 and a load LD1.

The switching power supply circuit 101 according to the first embodiment includes a diode bridge DB1, a DC/DC converter, an inductor L3, and a power factor correction IC 11.

The diode bridge DB1 is a rectifier circuit configured to generate a DC input voltage V2 from an AC input voltage V1.

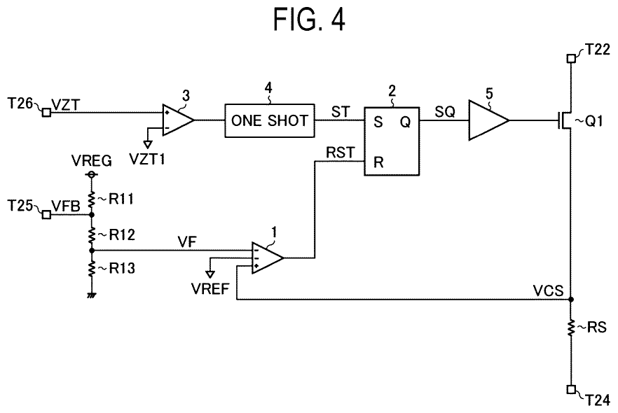

The DC/DC converter includes a switching element Q1 (see FIG. 4) configured to be connected in series to a transformer TR1 and a primary winding L5 of the transformer TR1, and is configured to generate a DC output voltage V3 from the DC input voltage V2 supplied to a primary circuit system and supply the generated DC output voltage V3 to the load LD1 of a secondary circuit system while electrically isolating the primary circuit system from the secondary circuit system. The transformer TR1 also includes a secondary winding L6 and an auxiliary winding L7 in addition to the primary winding L5.

The inductor L3 is disposed between the diode bridge DB1 and the DC/DC converter.

The power factor correction IC 11 includes the switching element Q1 (see FIG. 4) configured to control a current flowing through the inductor L3, and is configured to have a power factor correction function of suppressing a difference between a phase of the AC input voltage V2 and a phase of an AC input current supplied to the diode bridge DB1.

The switching power supply circuit 101 according to the first embodiment further includes the control IC 21. The control IC 21 is configured to control the switching element Q1 (see FIG. 4) according to a feedback voltage VFB based on the DC output voltage V3. The control IC 21 incorporates the switching element Q1 (see FIG. 4) of the DC/DC converter.

The switching power supply circuit 101 according to the first embodiment further includes a fuse F1, capacitors C1 to C10, inductors L1, L2, and L4, resistors R1 to R10, diodes D1 to D7, a phototransistor P1, a photodiode P2, and a shunt regulator S1.

The capacitor C1, the inductor L1, and the inductor L2 form a filter circuit. The inductor L4 is magnetically coupled to the inductor L3. The phototransistor P1 and the photodiode P2 form a photocoupler.

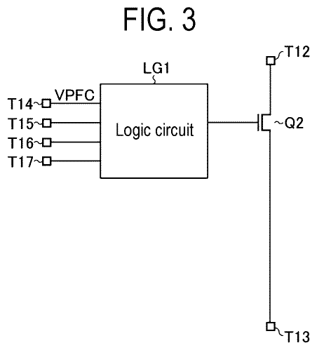

FIG. 3 is a diagram showing a schematic configuration of the power factor correction IC 11. The power factor correction IC 11 includes terminals T12 to T17, a switching element Q2 which is an n-type metal-oxide-semiconductor (NMOS) field effect transistor, and a logic circuit LG1. A drain of the switching element Q2 is connected to the terminal T12. A source of the switching element Q2 is connected to the terminal T13. In addition, the switching element Q2 may be a switching element other than the NMOS field effect transistor.

When a voltage VPFC applied to the terminal T14 is at a LOW level, the logic circuit LG1 turns the power factor correction function off and turns the switching element Q2 off.

When the voltage VPFC applied to the terminal T14 is at a HIGH level, the logic circuit LG1 turns the power factor correction function on and controls ON/OFF of the switching element Q2 according to voltages applied to the terminals T15 to T17. A signal (voltage) indicating whether or not a primary side current Ip is an overcurrent is applied to the terminal T15. A divided voltage of the DC input voltage V2 is applied to the terminal T16. A signal (voltage) for detecting a zero point of an inductor current IL flowing through the inductor L3 is applied to the terminal T17. When the voltage VPFC applied to the terminal T14 is at the HIGH level, the logic circuit LG1 first switches the switching element Q2 from OFF to ON. Thus, the inductor current IL is increased. Subsequently, the logic circuit LG1 compares the voltage applied to the terminal T15 with the voltage applied to the terminal T16, and switches the switching element Q2 from ON to OFF when the voltage applied to the terminal T15 becomes greater than the voltage applied to the terminal T16. During a period when the switching element Q2 is OFF, the inductor current IL decreases until it becomes 0 A. The logic circuit LG1 detects the zero point of the inductor current IL by the voltage applied to the terminal T17, and switches the switching element Q2 from OFF to ON when the zero point of the inductor current IL is detected.

FIG. 4 is a diagram showing a configuration of a control circuit provided in the control IC 21. The control circuit shown in FIG. 4 includes a comparator 1, a flip-flop 2, a ZT comparator 3, a one-shot circuit 4, a driver 5, a pull-up resistor R11, and voltage-dividing resistors R12 and R13.

A terminal T25 to which the feedback voltage VFB based on the DC output voltage V3 is applied is pulled up by the pull-up resistor R11. The feedback voltage VFB is divided by the voltage-dividing resistors R12 and R13 and is converted into a feedback voltage VF. A constant voltage VREG generated in the control IC 21 is applied to a first end of the pull-up resistor R11.

A sense resistor RS converts a source current of the switching element Q1, which is an NMOS field effect transistor, into a detection voltage VCS. In addition, the switching element Q1 may be a switching element other than the NMOS field effect transistor. The detection voltage VCS is supplied to a non-inverting input terminal (+) of the comparator 1. The feedback voltage VF is supplied to a first inverting input terminal (−) of the comparator 1. The reference voltage VREF for overcurrent protection is supplied to a second inverting input terminal (−) of the comparator 1.

The comparator 1 outputs a reset signal RST to a reset terminal (R) of the flip-flop 2.

A ZT voltage VZT, which is a divided voltage of a voltage generated in the auxiliary winding L7, is supplied to the terminal T26.

The ZT voltage VZT is applied to a non-inverting input terminal (+) of the ZT comparator 3. A threshold voltage VZT1 for zero current detection is supplied to an inverting input terminal (−) of the ZT comparator 3. The one-shot circuit 4 outputs a set signal ST based on an output of the ZT comparator 3. The set signal ST is supplied to a set terminal(S) of the flip-flop 2.

The driver 5 performs an on/off driving (switching) of the switching element Q1 to be turned on and turned off based on a Q signal SQ output from an output terminal (Q) of the flip-flop 2.

Here, a quasi-resonant control (QR control) by the control circuit shown in FIG. 4 will be described. First, when the set signal ST switched to a high level is output from the one-shot circuit 4, the flip-flop 2 is set and the switching element Q1 is turned on by the driver 5.

Turning-on is switching from an off state to an on state.

As a result, the primary side current Ip starts to flow through the switching element Q1 and the detection voltage VCS starts to rise. The primary side current Ip is a current that flows through the primary winding L5 (see FIG. 1). When the primary side current Ip increases and the detection voltage VCS rises above a lower one of the feedback voltage VF and the reference voltage VREF, the reset signal RST rises to a high level. As a result, the flip-flop 2 is reset and the switching element Q1 is turned off by the driver 5. Turning-off is switching from an on state to an off state.

When the switching element Q1 is turned off, the primary side current Ip stops flowing, and a secondary side current Is starts to flow. The secondary side current Is is a current that flows through the secondary winding L6 (see FIG. 1). When the switching element Q1 is in the off state, power stored in the primary winding L6 is supplied to the capacitor C9. When the supply of the power ends, the secondary side current Is stops flowing, and a drain voltage of the switching element Q1 falls. Therefore, the ZT voltage VZT also falls. When the ZT voltage VZT becomes equal to or lower than the threshold voltage VZT1, the one-shot circuit 4 outputs the set signal ST, which is a high-level pulse signal for a certain period of time, by the output from the comparator 3. As a result, the flip-flop 2 is set and the switching element Q1 is turned on.

As described above, in the QR control by the control circuit shown in FIG. 4, the drain voltage of the switching element Q1 is indirectly monitored by the ZT voltage VZT, and the switching element Q1 is turned on by detecting a voltage bottom of resonant oscillation of the drain voltage that is generated after energy stored in the transformer TR1 has been completely supplied to the secondary side.

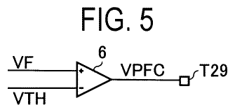

FIG. 5 is a diagram showing a configuration of a voltage generation circuit provided in the control IC 21. The voltage generation circuit shown in FIG. 5 generates the voltage VPFC for controlling the ON/OFF of the power factor correction function of the power factor correction IC 11. The voltage VPFC is output from the terminal T29 (see FIG. 1) to the outside of the control IC 21. Therefore, the control IC 21 can control the ON/OFF of the power factor correction function of the power factor correction IC 11.

The voltage generation circuit shown in FIG. 5 includes a comparator 6. The comparator 6 is configured to determine whether to turn on or turn off the power factor correction function of the power factor correction IC 11 according to a result of comparison between the feedback voltage VF and a threshold voltage VTH. The feedback voltage VF is supplied to a non-inverting input terminal (+) of the comparator 6. The threshold voltage VTH is supplied to an inverting input terminal (−) of the comparator 6. In addition, unlike the present embodiment, the comparator 6 may be configured to compare the feedback voltage VFB with the threshold voltage VTH.

When the feedback voltage VF is greater than the threshold voltage VTH, the voltage VPFC becomes a HIGH level. When the feedback voltage VF is not greater than the threshold voltage VTH, the voltage VPFC becomes a LOW level.

The terminal T29 of the control IC 21 is connected to the terminal T14 of the power factor correction IC 11 (see FIG. 1). When the power factor correction IC 11 receives the HIGH level voltage VPFC, the power factor correction IC 11 turns the power factor correction function on. When the power factor correction IC 11 receives the LOW level voltage VPFC, the power factor correction IC 11 turns the power factor correction function off. As a result, since the power factor correction function of the power factor correction IC 11 is turned off at light loads for which the power factor correction is not required, the switching power supply circuit 101 can suppress power consumption at light loads.

Here, when the power factor correction function of the power factor correction IC 11 is turned off, the value of DC input voltage V2 becomes a peak value (amplitude value) of the AC input voltage V1. Therefore, when the power factor correction function of the power factor correction IC 11 is turned off, the value of the DC input voltage V2 changes significantly by the AC input voltage V1.

Output power POUT of the switching power supply circuit 101 is expressed by the following equation:

POUT=(½)×Lp×Ippk²×Fsw,

where Lp is a primary side inductance, Ippk² is a primary side peak current, and Fsw is a switching frequency of the switching element Q1.

Further, the feedback voltage VFB is expressed by the following equation:

VFB=Rs×Ippk/G,

where Rs is a resistance value of the sense resistor, and G is a ratio of the feedback voltage VF to the feedback voltage VFB which is determined by resistance values of the voltage-dividing resistors R12 and R13.

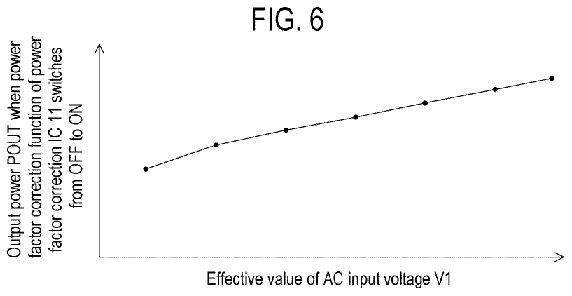

In the switching power supply circuit 101, since the control circuit shown in FIG. 4 performs the QR control, the switching frequency Fsw of the switching element Q1 changes by the effective value of the AC input voltage V1. More specifically, the switching frequency Fsw of the switching element Q1 becomes higher as the effective value of the AC input voltage V1 increases. Therefore, as shown in FIG. 6, the output power POUT when the power factor correction function of the power factor correction IC 11 switches from OFF to ON changes significantly according to the effective value of the AC input voltage V1. In other words, according to the effective value of the AC input voltage V1, the switching power supply circuit 101 may switch the power factor correction function of the power factor correction IC 11 from OFF to ON even when power factor correction is not required, or may not switch the power factor correction function of the power factor correction IC 11 from OFF to ON even when power factor correction is required.

### Second Embodiment

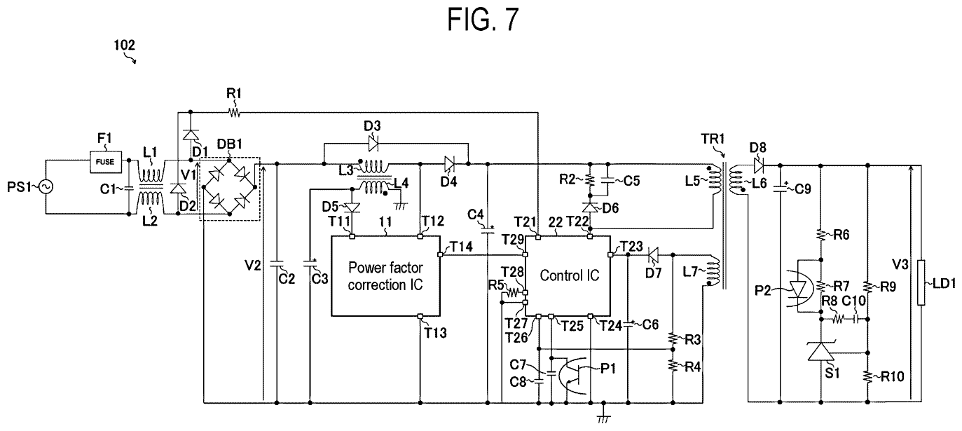

FIG. 7 is a diagram showing a configuration of a switching power supply circuit 102 according to a second embodiment. The switching power supply circuit 102 according to the second embodiment is configured to suppress the output power POUT from changing according to the effective value of the AC input voltage V1 when the power factor correction function of the power factor correction IC 11 switches from OFF to ON.

The switching power supply circuit 102 according to the second embodiment is different from the switching power supply circuit 101 according to the first embodiment in that the former includes a control IC 22 instead of the control IC 21, but is otherwise basically similar to the switching power supply circuit 101 according to the first embodiment. An external appearance of the control IC 22 is similar to that of the control IC 21.

The control IC 22 includes the control circuit shown in FIG. 4, like the control IC 21.

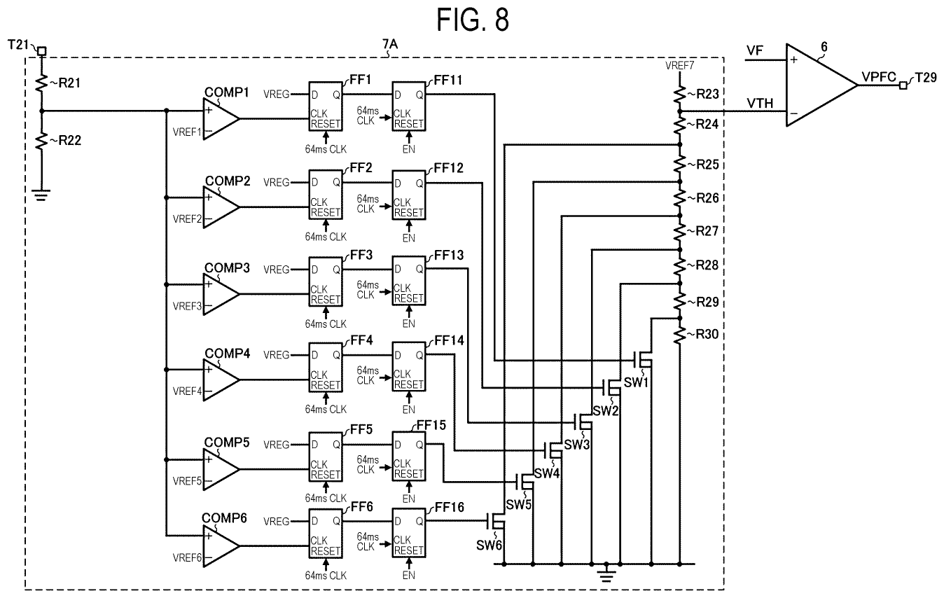

FIG. 8 is a diagram showing a first configuration example of a voltage generation circuit provided in the control IC 22. The voltage generation circuit shown in FIG. 8 generates a voltage VPFC for controlling ON/OFF of the power factor correction function of the power factor correction IC 11. The voltage generation circuit shown in FIG. 8 includes the comparator 6, similar to the voltage generation circuit shown in FIG. 5. The comparator 6 is configured to determine whether to turn on or turn off the power factor correction function of the power factor correction IC 11 according to a result of comparison between the feedback voltage VF and the threshold voltage VTH. The feedback voltage VF is supplied to the non-inverting input terminal (+) of the comparator 6. The threshold voltage VTH is supplied to the inverting input terminal (−) of the comparator 6. Unlike the present embodiment, the comparator 6 may be configured to compare the feedback voltage VFB with the threshold voltage VTH.

When the feedback voltage VF is greater than the threshold voltage VTH, the voltage VPFC becomes a HIGH level. When the feedback voltage VF is not greater than the threshold voltage VTH, the voltage VPFC becomes a LOW level.

The voltage generation circuit shown in FIG. 8 includes a suppression circuit 7A. The suppression circuit 7A is configured to suppress fluctuations in the output power POUT when the power factor correction function of the power factor correction IC 11 switches from OFF to ON.

The suppression circuit 7A is configured to change a value of the threshold voltage VTH according to the peak value (amplitude) of the AC input voltage V1 when the power factor correction function of the power factor correction IC 11 is turned off.

The suppression circuit 7A includes voltage-dividing resistors R21 and R22, comparators COMP1 to COMP6, flip-flops FF1 to FF6, flip-flops FF11 to FF16, switches SW1 to SW6, and voltage-dividing resistors R23 to R30.

Different reference voltages VREF1 to VREF6 are supplied to non-inverting input terminals (−) of the comparators COMP1 to COMP6, respectively. The reference voltages VREF1 to VREF6 have a magnitude relationship of the reference voltage VREF1<the reference voltage VREF2<the reference voltage VREF3<the reference voltage VREF4<the reference voltage VREF5<the reference voltage VREF6.

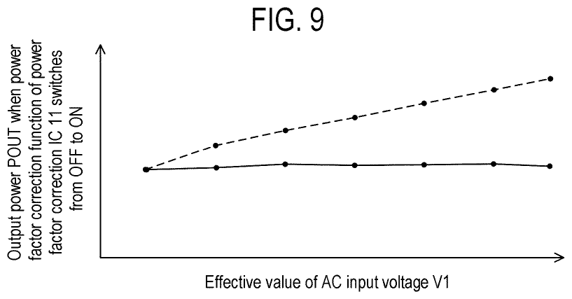

The switches SW1 to SW6 are switches to select a resistor to be short-circuited to ground from among the voltage-dividing resistors R25 to R30. As the peak value (amplitude) of the AC input voltage V1 increases, the switches SW1 to SW6 are turned on sequentially, and the value of the threshold voltage VTH decreases. Therefore, as shown in FIG. 9, the output power POUT when the power factor correction function of the power factor correction IC 11 switches from OFF to ON is almost constant regardless of the effective value of the AC input voltage V1. In other words, the switching power supply circuit 102 can prevent the power factor correction function of the power factor correction IC 11 from switching from OFF to ON even when power factor correction is not required, or can prevent the power factor correction function of the power factor correction IC 11 from not switching from OFF to ON even when power factor correction is required. In addition, in FIG. 9, for comparison, the relationship in the first embodiment between the effective value of the AC input voltage V1 and the output power POUT when the power factor correction function of the power factor correction IC 11 switches from OFF to ON is shown by a dotted line.

A frequency of a reset signal supplied to each reset input terminal of the flip-flops FF1 to FF6 and a frequency of a clock signal supplied to each clock input terminal of the flip-flops FF11 to FF16 are set to be lower than 50 Hz, so that the peak value (amplitude) of the 50 Hz or 60 Hz AC input voltage V1 (commercial AC voltage in Japan) can be detected by comparators COMP1 to COMP6, the flip-flops FF1 to FF6, and the flip-flops FF11 to FF16.

The suppression circuit 7A is configured to fix the value of the threshold voltage VTH regardless of the peak value (amplitude) of the AC input voltage V1 when the power factor correction function of the power factor correction IC 11 is turned on. Specifically, when the power factor correction function of the power factor correction IC 11 is turned on, the flip-flops FF11 to FF16 are reset by a reset signal EN supplied to each reset input terminal of the flip-flops FF11 to FF16, and the switches SW1 to SW6 are all turned off. The reason is that when the power factor correction function of the power factor correction IC 11 is turned on, the DC input voltage V2 is constant regardless of the peak value (amplitude) of the AC input voltage V1, and it is not necessary to change the value of the threshold voltage VTH.

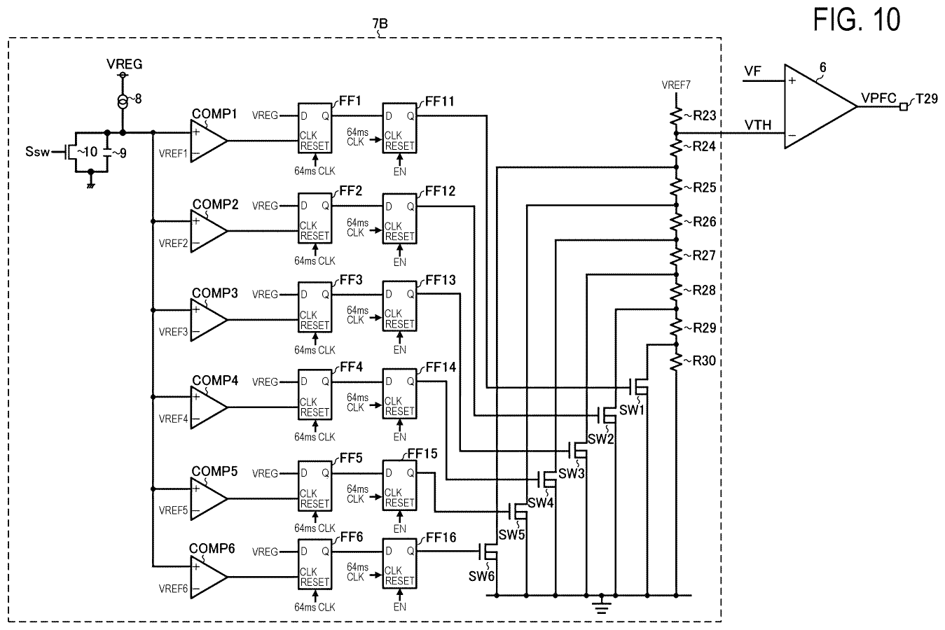

FIG. 10 is a diagram showing a second configuration example of the voltage generation circuit provided in the control IC 22. The voltage generation circuit shown in FIG. 10 is different from the voltage generation circuit shown in FIG. 8 in that the former includes a suppression circuit 7B instead of the suppression circuit 7A, but is otherwise basically similar to the voltage generation circuit shown in FIG. 8.

The suppression circuit 7A is configured to change the value of the threshold voltage VTH according to the switching frequency Fsw of the switching element Q1 when the power factor correction function of the power factor correction IC 11 is turned off.

The suppression circuit 7B has a configuration in which the voltage-dividing resistors R21 and R22 are removed from the suppression circuit 7A, and a constant current source 8, a capacitor 9, and a discharge switch 10 are added. The capacitor 9 is charged by a constant current output from the constant current source 8. The capacitor 9 is discharged when the discharge switch 10 is turned on. The discharge switch 10 is ON/OFF-controlled by a signal Ssw that is synchronized with a control signal supplied to a control terminal (gate) of the switching element Q1. As the switching frequency Fsw of the switching element Q1 decreases, the peak value of a charging voltage of the capacitor 9 increases.

### Others

The above-described embodiments should be considered to be illustrative in all respects and not restrictive. The technical scope of the present disclosure is indicated by the claims, not by the description of the above-described embodiments, and should be understood to include all changes that fall within the meaning and scope of the claims.

For example, in the above-described first and second embodiments, the switching element Q1 is incorporated in the control IC 21 or the control IC 22, but the switching element Q1 may be provided outside the control IC 21 or the control IC 22.

For example, in the above-described second embodiment, when the power factor correction function of the power factor correction IC 11 is turned off, the value of the threshold voltage VTH is changed according to the peak value (amplitude) of the AC input voltage V1 or the switching frequency Fsw of the switching element Q1, but instead of the value of the threshold voltage VTH, the ratio of the feedback voltage VF to the feedback voltage VFB or the resistance value of the sense resistor RS may be changed.

### Supplementary Notes

Supplementary notes are provided for the present disclosure in which specific configuration examples are shown in the above-described embodiments.

A control IC (21, 22) of the present disclosure is a control IC configured to be a component of a switching power supply circuit (101, 102), wherein the switching power supply circuit includes: a rectifier circuit (DB1) configured to generate a DC input voltage from an AC input voltage; a DC/DC converter including a transformer (TR1) and a first switching element (Q1) connected in series with a primary winding of the transformer, and configured to generate a DC output voltage from the DC input voltage supplied to a primary circuit system and supply the generated DC output voltage to a load (LD1) of a secondary circuit system while electrically isolating the primary circuit system from the secondary circuit system; an inductor (L3) disposed between the rectifier circuit and the DC/DC converter; and a power factor correction IC (11) including a second switching element (Q2) configured to control a current flowing through the inductor, and configured to have a power factor correction function of suppressing a difference between a phase of the AC input voltage and a phase of an AC input current supplied to the rectifier circuit, wherein the control IC includes: a first terminal (T25) configured to receive a feedback voltage based on the DC output voltage; and a second terminal (T29), wherein the control IC is configured to control the first switching element according to the feedback voltage, and wherein the control IC is further configured to output a voltage for ON/OFF-controlling the power factor correction function from the second terminal (first configuration).

Since the control IC of the first configuration outputs the voltage for ON/OFF-controlling the power factor correction function of the power factor correction IC from the second terminal, it is possible to control ON/OFF of the power factor correction function of the power factor correction IC.

The control IC of the first configuration may incorporate the first switching element (second configuration).

The control IC of the first or second configuration may be configured to determine whether to turn on or turn off the power factor correction function according to a result of comparison between a voltage based on the feedback voltage and a threshold voltage (third configuration).

The control IC of the third configuration may further include a suppression circuit (7A, 7B) configured to suppress fluctuations in DC output power supplied to the load when the power factor correction function switches from OFF to ON (fourth configuration).

In the control IC of the fourth configuration, the suppression circuit may be further configured to change the threshold voltage according to an amplitude of the AC input voltage when the power factor correction function is turned off (fifth configuration).

In the control IC of the fourth configuration, the suppression circuit may be further configured to change the threshold voltage according to a switching frequency of the first switching element when the power factor correction function is turned off (sixth configuration).

The control IC of the fourth configuration may be further configured to control the first switching element according to a divided voltage of the feedback voltage, and the suppression circuit may be further configured to change a ratio of the divided voltage to the feedback voltage according to an amplitude of the AC input voltage when the power factor correction function is turned off (seventh configuration).

The control IC of the fourth configuration may be further configured to control the first switching element according to a divided voltage of the feedback voltage, and the suppression circuit may be further configured to change a ratio of the divided voltage to the feedback voltage according to a switching frequency of the first switching element when the power factor correction function is turned off (eighth configuration).

The control IC of the fourth configuration may further include a sense resistor (RS) configured to convert a current flowing through the first switching element into a voltage, and the suppression circuit may be further configured to change a resistance value of the sense resistor according to an amplitude of the AC input voltage when the power factor correction function is turned off.

The control IC of the fourth configuration may further include a sense resistor (RS) configured to convert a current flowing through the first switching element into a voltage, and the suppression circuit may be further configured to change a resistance value of the sense resistor according to a switching frequency of the first switching element when the power factor correction function is turned off (tenth configuration).

A switching power supply circuit (101, 102) of the present disclosure includes the control IC (21, 22) of any one of the first to tenth configurations (eleventh configuration).

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A control integrated circuit (IC) configured to be a component of a switching power supply circuit,
wherein the switching power supply circuit comprises:
a rectifier circuit configured to generate a direct current (DC) input voltage from an alternate current (AC) input voltage;
a DC/DC converter including a transformer and a first switching element connected in series with a primary winding of the transformer, and configured to generate a DC output voltage from the DC input voltage supplied to a primary circuit system and supply the generated DC output voltage to a load of a secondary circuit system while electrically isolating the primary circuit system from the secondary circuit system;
an inductor disposed between the rectifier circuit and the DC/DC converter; and
a power factor correction IC including a second switching element configured to control a current flowing through the inductor, and configured to have a power factor correction function of suppressing a difference between a phase of the AC input voltage and a phase of an AC input current supplied to the rectifier circuit,
wherein the control IC comprises:
a first terminal configured to receive a feedback voltage based on the DC output voltage; and
a second terminal,
wherein the control IC is configured to control the first switching element according to the feedback voltage, and
wherein the control IC is further configured to output a voltage for ON/OFF-controlling the power factor correction function from the second terminal.

2. The control IC of claim 1, which incorporates the first switching element.

3. The control IC of claim 1, which is configured to determine whether to turn on or turn off the power factor correction function according to a result of comparison between a voltage based on the feedback voltage and a threshold voltage.

4. The control IC of claim 3, further comprising a suppression circuit configured to suppress fluctuations in DC output power supplied to the load when the power factor correction function switches from OFF to ON.

5. The control IC of claim 4, wherein the suppression circuit is further configured to change the threshold voltage according to an amplitude of the AC input voltage when the power factor correction function is turned off.

6. The control IC of claim 4, wherein the suppression circuit is further configured to change the threshold voltage according to a switching frequency of the first switching element when the power factor correction function is turned off.

7. The control IC of claim 4, which is further configured to control the first switching element according to a divided voltage of the feedback voltage,
wherein the suppression circuit is further configured to change a ratio of the divided voltage to the feedback voltage according to an amplitude of the AC input voltage when the power factor correction function is turned off.

8. The control IC of claim 4, which is further configured to control the first switching element according to a divided voltage of the feedback voltage,
wherein the suppression circuit is further configured to change a ratio of the divided voltage to the feedback voltage according to a switching frequency of the first switching element when the power factor correction function is turned off.

9. The control IC of claim 4, further comprising a sense resistor configured to convert a current flowing through the first switching element into a voltage,
wherein the suppression circuit is further configured to change a resistance value of the sense resistor according to an amplitude of the AC input voltage when the power factor correction function is turned off.

10. The control IC of claim 4, further comprising a sense resistor configured to convert a current flowing through the first switching element into a voltage,
wherein the suppression circuit is further configured to change a resistance value of the sense resistor according to a switching frequency of the first switching element when the power factor correction function is turned off.

11. A switching power supply circuit comprising the control IC of claim 1.
